(19) United States
(12) Patent Application Publication
(10) Pub. No.: US 2009/0060339 A1
(43) Pub. Date: Mar. 5, 2009

(54) Method of organizing chinese characters

(76) Inventor: Sutoyo Lim, Temple City, CA (US)

Correspondence Address: DAVID AND RAYMOND PATENT FIRM, 108 N. YNEZ AVE., SUITE 128, MONTEREY PARK, CA, 91754, US

(21) Appl. No.: 12/156,961

(22) Filed: Jun. 5, 2008

Related U.S. Application Data
(60) Provisional application No. 60/967,324, filed on Sep. 4, 2007.

(51) Int. Cl. G06K 9/18

(52) U.S. Cl. 382/185

(57) ABSTRACT

A method of organizing Chinese characters includes the steps of: generating Stroke Set; generating Symbol Set; generating Stroke Code Set; generating a sequential code for each of the Chinese characters to be organized; generating a spatial code for each of the Chinese characters to be organized; generating a character code for each of the Chinese characters to be organized; and organizing said character codes together with related the Chinese characters to be organized such that a Chinese character is adapted to be located by first locating the related character code of the Chinese character, then locating the Chinese character in responsive to the related character code of the Chinese character.

### CROSS REFERENCE OF RELATED APPLICATION

This is a non-provisional application of a provisional application having an application No. 60/967,324 and a filing date of Sep. 4, 2007.

### BACKGROUND OF THE PRESENT INVENTION

1. Field of Invention

The present invention relates to Chinese characters, and more particularly to a method of organizing Chinese characters applicable to but not limited to compiling a Chinese Dictionary, word processing Chinese characters, and data processing Chinese characters, that allows a user to efficiently and easily organize Chinese characters, to efficiently and easily locate a Chinese character, to efficiently and easily word process Chinese characters, and to efficiently and easily data process Chinese characters.

2. Description of Related Arts

An ideal method of organizing Chinese characters should include the following qualities:

Easy to learn where rules are simple, few, and easy to grasp,

Easy to retain and regain when not used regularly,

Easy to use,

Efficient to use where a Chinese character is easily and quickly located such as in the case of using a dictionary, word processing software, or data processing,

Applicable for different groups of users of Chinese characters where different groups may have different pronunciations on the same Chinese character,

High in uniqueness of relative ordering,

High in obviousness of the relative ordering of two Chinese characters at a glance without excessive inspection or analysis,

Optimally making use of the skills learned when learning to write Chinese characters. Lacking this compels the user of a method to spend more time and effort to learn the method. Also, the lack of using a mastered skill causes loss of the skill, for example, capability of writing Chinese character by hand is lessen by using word processing relying on pronunciations.

Easy to decipher the Chinese character represented by a code. This is useful to verbally differentiate Chinese characters with the same pronunciations or to instruct someone on how to write a Chinese character. Easiness to decipher is closely related to code uniqueness and the simplicity of rules used in generating the codes.

Prior arts of organizing Chinese characters include very few of the ideal qualities mentioned above. Therefore, when applying to compiling a dictionary, data processing, or word processing, prior arts are inefficient and difficult to use.

The following are brief discussions of some of the existing methods of organizing Chinese characters:
Method of organizing Chinese characters using Hanyu Pinyin.

This method relies on pronunciations of Chinese characters. Users that do not know the pronunciation of a Chinese character will have difficulties in locating the Chinese character in a dictionary, in word processing software, or in data processing using this method. Some of the disadvantages of this method are as follows:

Not easy to use. Without knowing the pronunciation of a Chinese character makes it almost impossible to use a dictionary or word processing software relying on pronunciations. Low in uniqueness of relative ordering and low in obviousness of relative ordering also make this method not easy to use.

Not applicable to many groups of users with different pronunciations of the Chinese characters.

Very low in uniqueness of relative ordering even with the application of additional rules. Many Chinese characters share the same pronunciations and the number of strokes.

Low in obviousness of the relative order of two Chinese characters without knowing the pronunciations. Many Chinese characters have the same pronunciation; therefore, require additional rules to order the characters.

Not optimally making use of the skills learned when learning to write Chinese characters. Using this method regularly in word processing software, over times, a user loses skills in writing Chinese characters by hand. Being able to write Chinese characters by hand is still needed in many occasions.

Not easy to decipher a Chinese character represented by Hanyu Pinyin. Often, a pronunciation represents many Chinese characters, as many as up to more than 40 characters.
Organizing Chinese characters using radicals (bushou) of the Chinese characters.

This method relies on being able to identify the radical. Some of the disadvantages of this method are as follows:

Not easy to learn. There is no consistent way of identifying the radical of a Chinese character. For example, according to a source or author, the radical for the Chinese character ‘—’ is ‘—’, the radical for ‘ [symbol] ’ is ‘ [symbol] ’, but the radical for [symbol] is ‘—’. The numbers of radicals are different in various sources or authors. Depending on the source or author, the number of radicals varies from approximately 189 to 540.

Not easy to retain and regain when not used regularly. It is almost impossible to memorize all the radicals of approximately 189 to 540 radicals and the order of the radicals; therefore, this method depends heavily on the availability of a list of radicals. Without an organized list of radicals readily available, the method is almost impossible to use.

Not easy to use. The approximately 189 to 540 radicals require additional rules to organize. The rules used to organize the radicals are cumbersome to use. Besides, each radical includes up to several hundreds of Chinese characters which also require additional rules to organize. Many steps and analysis are required to apply this method.

Not efficient to use. The considerable number of rules, steps, and analysis required in applying this method cause inefficiency.

Low in uniqueness of relative ordering. A radical includes up to several hundreds of Chinese characters. Even applying additional rules such as the counting the number of strokes produce limited improvements.

Low in obviousness in the relative ordering of two Chinese characters at a glance without excessive inspection analysis.
Organizing Chinese characters using the order of strokes

This method relies on the order of strokes in writing Chinese characters and the strokes used in writing Chinese characters. Some of the disadvantages of this method are:

Inefficient to use as a result of low in uniqueness of relative ordering. The occurrence of several characters with the same strokes and order of strokes are very common.

Low in uniqueness of relative ordering. The occurrence of several characters with the same strokes and order of strokes are very common.

Low in obviousness of the relative ordering of two Chinese characters at a glance without excessive inspection or analysis. There is no universal agreement on the order of the strokes used in writing Chinese characters.

Not easy to decipher the Chinese character given only the strokes and order of strokes. The occurrence of several characters with the same strokes and same order of strokes are very common.
Organizing Chinese characters using codes for components of Chinese characters.

This method relies on the ability to resolve a Chinese character into components accurately. Some of the disadvantages of this method are:

Not easy to learn. The rules are numerous and complicated. The components used can be as many as approximately 100 components. Very often, a Chinese character can be resolved in several sets of components where a user of the method has to decide which set is the most suitable to use.

Not easy to retain and regain when not used regularly. The numerous of components and many ways of resolving a Chinese character into components make it difficult for a user to use this method occasionally.

Not easy to use for a casual user. This method requires special training and regular use to retain the skill.

Not efficient to use for a casual user. This method requires special training and skill in resolving a Chinese character into an appropriate set of components.

Low in obviousness of the relative ordering of two Chinese characters at a glance where this method requires special skill and analysis in resolving a Chinese character into an appropriate set of components.

Not easy to decipher the Chinese character represented by a code where the occurrence of several components sharing the same component code is often.
Organizing Chinese characters basing on the forms of the four corners of a Chinese character.

Each of the four corners of a Chinese character is assigned a digit according to the forms of the corners. The four digits form a code that represents the Chinese character. Some of the disadvantages of this method are:

Not easy to learn where there are numerous of shapes to consider, and the shapes are to be grouped and to be represented by one of the ten numeral digits 0 through 9. Also, there are many exceptions to the rules on the corners to be used.

Not easy to use. There are many exceptions to the rules. In other words, the rules are complicated.

Not efficient to use. Often, a code is shared by many Chinese characters, as many as up to more than 40 Chinese characters.

Low in Uniqueness of relative ordering. Without additional rules, the uniqueness of relative ordering is low, but additional rules make it less efficient to use.

Low in obviousness of the relative ordering of two Chinese characters at a glance where the method requires complicated analysis.

Not optimally making use of the skill learned when learning to write Chinese characters.

Not easy to decipher the Chinese character represented by a code where the occurrence of many Chinese characters sharing a code is very common.

### SUMMARY OF THE PRESENT INVENTION

A main object of the present invention is to provide a method of organizing Chinese characters, which comprises means for compiling a dictionary of Chinese characters where a Chinese character can be located efficiently and easily.

Another object of the present invention is to provide a method of organizing Chinese characters, which comprises means for data and word processing where a Chinese character can be processed efficiently and easily.

Another object of the present invention is to provide a method of organizing Chinese characters, which is easy to learn where rules are simple, few, and easy to grasp.

Another object of the present invention is to provide a method of organizing Chinese characters, which is easy to retain and regain when not used regularly.

Another object of the present invention is to provide a method of organizing Chinese characters, which is easy to use.

Another object of the present invention is to provide a method of organizing Chinese characters, which is efficient to use where a Chinese character is easily and quickly located such as in the case of using a dictionary, word processing software, or data processing.

Another object of the present invention is to provide a method of organizing Chinese characters, which is applicable for different groups of users of Chinese characters where different groups have different pronunciations on the same Chinese character.

Another object of the present invention is to provide a method of organizing Chinese characters, which is high in uniqueness of relative ordering.

Another object of the present invention is to provide a method of organizing Chinese characters, which is high in obviousness of the relative ordering of two Chinese characters at a glance without excessive inspection or analysis.

Another object of the present invention is to provide a method of organizing Chinese characters, which is optimally making use of the skills learned when learning to write Chinese characters.

Another object of the present invention is to provide a method of organizing Chinese characters where deciphering the Chinese character represented by a code is easy.

Another object of the present invention is to provide a method of organizing Chinese characters, which comprises means for learning Chinese characters efficiently and accurately where strokes, orders of strokes, and relationship of strokes are presented clearly.

Another object of the present invention is to provide a method of organizing Chinese characters, which comprises means for creating games where Chinese characters are to be guessed if character codes are provided.

Accordingly, the present invention provides a means for compiling a Chinese dictionary where a user locates a Chinese character efficiently and easily, a means to efficiently and easily data and word processing Chinese characters, and a means for organizing Chinese characters where a user locates a Chinese character efficiently and easily.

These and other objectives, features, and advantages of the present invention will become apparent from the following detailed description, the accompanying drawings, and the appended claims.

### BRIEF DESCRIPTION OF THE DRAWINGS

In the drawings, closely related figures have the same number but different alphabetic suffixes.

FIG. 1A and FIG. 1B are tables showing the 31 strokes used for writing Chinese characters in standard printing style together with the name of each stroke. The strokes are ordered according to the frequency of usage starting from the stroke with the highest frequency of usage.

FIG. 2A and FIG. 2B are tables showing the stroke code for each of the 31 strokes used for writing Chinese characters in standard printing style together with the name of each stroke. The strokes are ordered according to the frequency of usage starting from the stroke with the highest frequency of usage.

Table 1 shows samples of the generated sequential codes in responsive to the corresponding Chinese characters.

Table 2 shows samples of the generated Spatial Codes in responsive to the corresponding sequential codes and Chinese characters.

Table 3 shows samples of the generated Character code in responsive to the corresponding spatial codes and Chinese characters.

Table 4 shows samples of the alphabetically ordered Character code in responsive to the corresponding spatial codes and Chinese characters.

### DETAILED DESCRIPTION OF THE PREFERRED EMBODIMENT

A preferred embodiment of method of the present invention is described as follows:

1. Definitions and descriptions of special terms listed alphabetically:

Character Code

A character code is a code that represents a Chinese character. In a few cases, two or three Chinese characters may be represented by the same character code. A character code is constructed from a spatial code by inserting grouping agents as many as desired including inserting no grouping agent into the spatial code. In organizing or sorting character codes, the grouping agents are ignored. The grouping agents provide a means for making a character code easier for direct human use. For an electronic application where no direct human use of character codes, no grouping agent is needed. If no grouping agent is inserted into a spatial code in constructing a character code, the spatial code is the character code.

Character Code Table

Character Code Table is a table comprising at least Chinese characters field and character code field. The Chinese characters field includes Chinese characters to be organized. The character code field includes character codes such that in a record, the character code represents the Chinese character of the record.

Combination of Members of a Set

A combination of members of a set is one or more members of the set, treated as a single entity.

Combination of Symbols

A combination of symbols is one or more members of a set of symbols, where a blank space is also considered a symbol in addition to other symbols, treated as a single entity.

Field

A field is a column of a table.

Grouping Agent

A grouping agent is a blank space or a symbol that is not a member of Symbol Set. A grouping agent is used for grouping stroke codes in a spatial code by inserting as many grouping agent as desired, including inserting no grouping agent. For the preferred embodiment, the grouping agent is a blank space.

High Frequency Stroke Subset

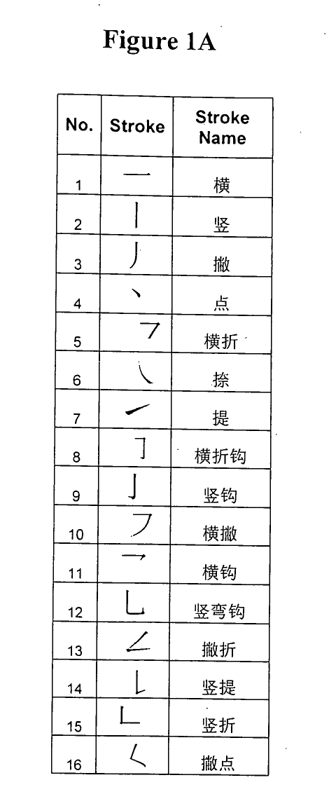

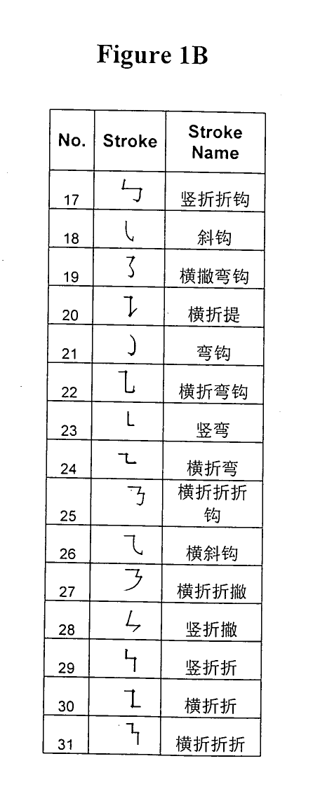

High Frequency Stroke Subset is one of two disjoint subsets of Stroke Set, High Frequency Stroke Subset and Low Frequency Stroke Subset, where each member of the High Frequency Stroke Subset has a higher frequency of usage than each member of the Low Frequency Stroke Subset. For the preferred embodiment, the 21 strokes of highest frequencies of usage listed in FIG. 1A and FIG. 1B are members of the High Frequency Stroke Subset, and the 10 strokes of lowest frequencies of usage listed in FIG. 1B are members of the Low Frequency Stroke Subset.

Horizontal-Horizontal Relationship

Horizontal-Horizontal Relationship is one of Spatial Relationships. Please see Spatial Relationship.

Horizontal-Vertical-Horizontal Relationship

Horizontal-Vertical-Horizontal Relationship is one of Spatial Relationships. Please see Spatial Relationship.

Intersections Relationship

Intersections Relationship is one of Spatial Relationships. Please see Spatial Relationship.

Low Frequency Stroke Subset

Low Frequency Stroke Subset is one of two disjoint subsets of Stroke Set, High Frequency Stroke Subset and Low Frequency Stroke Subset, where each member of the High Frequency Stroke Subset has a higher frequency of usage than each member of the Low Frequency Stroke Subset. For the preferred embodiment, the 21 strokes of highest frequencies of usage listed in FIG. 1A and FIG. 1B are members of the High Frequency Stroke Subset, and the 10 strokes of lowest frequencies of usage listed in FIG. 1B are members of the Low Frequency Stroke Subset.

Main Subset

Main Subset is a subset of Symbol Set where the Symbol Set is partitioned into two disjoint subsets, Main Subset and Modifier Subset, such that a member or combination of members of Modifier Subset is used to modify a member of the Main Subset, a code, group of codes, a symbols, or symbols. For the preferred embodiment where the English alphabet is selected to be Symbol Set, each of the 21 consonants is a member of Main Subset and each of the five vowels is a member of Modifier Subset.

Main-Alphabet Subset

Main-Alphabet Subset is a subset of the English alphabet where each of the 21 consonants is a member of Main-Alphabet Subset. When the English alphabet is selected to be Symbol Set, Main-Alphabet Subset is Main Subset.

Modifier Subset

Modifier Subset is a subset of Symbol Set where the Symbol Set is partitioned into two disjoint subsets, Main Subset and Modifier Subset, such that a member or combination of members of Modifier Subset is used to modify a member of the Main Subset, a code, group of codes, a symbol, or symbols. For the preferred embodiment where the English alphabet is selected to be Symbol Set, each of the 21 consonants is a member of Main Subset and each of the five vowels is a member of Modifier Subset.

Modifier-Alphabet Subset

Modifier-Alphabet Subset is a subset of the English alphabet where each of the five vowels is a member of Modifier-Alphabet Subset. When the English alphabet is selected to be Symbol Set, Modifier-Alphabet Subset is Modifier Subset.

Modify

To modify a code, a group of codes, a symbol, or a group of symbols is to insert a symbol or combination of symbols next to the code, group of codes, a symbol, or group of symbols to be modified so that the inserted symbol or combination of symbols together with the code, group of codes, a symbol, or group of symbol modified are treated as a unit. For the preferred embodiment, the preferred method of modifying is such that the modified is in front of the modifier.

Record

A record is a row of a table.

Sequential Code

A sequential code is a code related to a Chinese character such that a sequential code includes all the stroke codes of strokes used in writing the Chinese character arranged sequentially according to the order of writing the strokes. For the preferred embodiment, [symbol] has four strokes represented by ‘j’, ‘j’, ‘k’, and ‘f’. After arranging the strokes according to the order of writing the strokes, the sequential code for [symbol] is ‘jjkf’.

Sequential Code Table

Sequential Code Table is a table comprising of at least Chinese characters field and sequential code field. The Chinese characters field includes Chinese characters to be organized. The sequential code field includes sequential codes such that in a record, a sequential code is related to the Chinese character of the record.

Sequential Relationship

A Sequential Relationship is a relationship between a stroke or a stroke code of a Chinese character and one or more strokes or stroke codes of the Chinese character according to the order of the writing of the strokes of the Chinese character. A stroke code is said to be earlier in a Sequential Relationship relative to a second stroke code if the stroke represented by the stroke code is written first relative to the second stroke represented by the second stroke code, similarly, a stroke is said to be earlier in a Sequential Relationship relative to a second stroke if the stroke is written first relative to the second stroke.

Set

A set a collection of objects or elements classed together. The objects in a set are called the members of the set. For example, a stroke is a member of Stroke Set.

Spatial Code

A spatial code is a code related to a Chinese character such that a spatial code is constructed by modifying a sequential code according to the Spatial Relationships of the strokes in the Chinese character.

Spatial Code Table

Spatial Code Table is a table comprising of at least Chinese characters field and spatial code field. The Chinese characters field includes Chinese characters to be organized. The spatial code field includes spatial codes such that in a record, a spatial code is related to the Chinese character of the record.

Spatial Relationship

A Spatial Relationship of a stroke relative to one or more strokes earlier in Sequential Relationship is any of the relationships described in the followings:

(i) Intersections Relationship

Intersections Relationship is the number of intersections of a stroke and other strokes earlier in a Sequential Relationship of a Chinese character. For the preferred embodiment, each intersection is represented by one ‘e’; therefore, two intersections are represented by ‘ee’, three intersections are represented by ‘eee’, etc.

(ii) Horizontal-Horizontal Relationship

Horizontal-Horizontal Relationship is the relative length of two horizontal strokes ( [symbol] ) where the second horizontal stroke is written right after the first horizontal stroke earlier in Sequential Relationship and the second horizontal stroke is written right under the first horizontal stroke. There are two types of Horizontal-Horizontal Relationships. The first type of Horizontal-Horizontal Relationship is such that the second horizontal stroke is longer than the first horizontal stroke. The second type of Horizontal-Horizontal Relationship is such that the second horizontal is shorter than the first horizontal stroke. For the preferred embodiment, when the second horizontal stroke is shorter than the first horizontal stroke, the Horizontal-Horizontal Relationship is represented by ‘i’.

(iii) Horizontal-Vertical-Horizontal Relationship

Horizontal-Vertical-Horizontal Relationship is the relative length of two horizontal strokes among three strokes, a horizontal stroke ( [symbol] , a vertical stroke ( [symbol] , and a horizontal stroke [symbol] written one right after another respectively, and the second horizontal stroke is written under the first horizontal stroke earlier in Sequential Relationship. There are two types of Horizontal-Vertical-Horizontal Relationships. The first type of Horizontal-Vertical-Horizontal Relationship is such that the second horizontal stroke is longer than the first horizontal stroke. The second type of Horizontal-Vertical-Horizontal Relationship is such that the second horizontal is shorter than the first horizontal stroke. For the preferred embodiment, when the second horizontal stroke is shorter than the first horizontal stroke, the Horizontal-Vertical-Horizontal Relationship is represented by ‘i’.

(iv) Two-Stroke Relationship

Two-Stroke Relationship is the relative position of the two strokes [symbol] and [symbol] written one right after another respectively in a Chinese character with the forms of [symbol] (ren)’, ‘ [symbol] (ba)’, or ‘ [symbol] (ru)’ and the two strokes are not separated by another stroke. There are three types of Two-Stroke Relationships, type ‘ [symbol] (ren)’, type ‘ [symbol] (ba)’, and type ‘ [symbol] (ru)’. For the preferred embodiment, the Two-Stroke Relationship in ‘ [symbol] (ba)’ is represented by ‘oa’ and the Two-Stroke Relationship in ‘ [symbol] (ru)’ is represented by ‘oe’.

(v) Three-Stroke Relationship

Three-Stroke Relationship is the relative position of the three strokes ‘ [symbol] and [symbol] written one right after another respectively in a Chinese character with the forms ‘ [symbol] (ji)’, ‘ [symbol] (yi)’, or ‘ [symbol] (si)’. There are three types of Three-Stroke Relationship, type ‘ [symbol] (ji)’, type ‘ [symbol] (yi)’, and type [symbol] (si)’. For the preferred embodiment, the Three-Stroke Relationship in ‘ [symbol] (yi)’ is represented by ‘oa’ and the Three-Stroke Relationship in ‘ [symbol] (si)’ is represented by ‘oe’.

Stroke

A stroke ( [symbol] ) is one of the smallest elements in the structure of Chinese characters. For the preferred embodiment, there are 31 strokes as shown in FIG. 1A and FIG. 1B.

Stroke Code

A stroke code is a code that represents a stroke. A stroke code is a member of Stroke Code Set. Where contexts are clear, ‘stroke code’ and ‘stroke’ may be used interchangeably. For the preferred embodiment, all the stroke codes are listed in FIG. 1A and FIG. 1B.

Stroke Code Set

Stroke Code Set is a set where each member of Stroke Code Set is a member or combination of members of Symbol Set such that each member of Stroke Set is represented by a member of Stroke Code Set. A member of Stroke Code Set is called a stroke code. Where contexts are clear, ‘stroke code’ and ‘stroke’ may be used interchangeably. For the preferred embodiment, each member of Stroke Code Set represents one member of Stroke Set and each member of Stroke Set is represented by one member of Stroke Code Set.

Stroke Set

Stroke Set is a set including all the strokes used in writing Chinese characters. A member of Stroke Set, called a stroke, is a stroke in writing Chinese characters. For the preferred embodiment, each of the 31 strokes used in the standard printing style of Chinese characters is a member of Stroke Set.

Symbol Set

Symbol Set is a set including symbols that can be arranged in an ordered list that facilitates locating a member of the said Symbol Set. For the preferred embodiment, the English alphabet is selected to be Symbol Set.

Three-Stroke Relationship

Three-Stroke Relationship is one of Spatial Relationships. Please see Spatial Relationship.

Two-Stroke Relationship

Two-Stroke Relationship is one of Spatial Relationships. Please see Spatial Relationship.

2. Chinese characters to be organized

Let us assume the Chinese characters to be organized for compiling a dictionary of Chinese characters, or data and word processing are: [symbol] [symbol] [symbol] [symbol] [symbol] [symbol] and

[symbol]

3. Generating Stroke Set

Stroke Set is a set including all of the strokes used in writing Chinese characters. A member of Stroke Set, called stroke, is a stroke in writing Chinese characters.

There are a total of 31 strokes used in a standard printed style of Chinese characters as listed FIG. 1A and FIG. 1B. Let the 31 strokes listed in FIG. 1A and FIG. 1B be the members of the Stroke Set.

4. Generating Symbol Set

Symbol Set is a set including symbols that can be arranged in an ordered list that facilitates locating a member of the said Symbol Set.

Let the English alphabet be the Symbol Set.

5. Partitioning the English alphabet into Main Subset and Modifier Subset

The English alphabet is partitioned into two disjoint subsets called Main Subset and Modifier Subset. The members of Main Subset are the 21 consonants of the English alphabet. The members of the Modifier Subset are the five vowels of the English alphabet.

A member or a combination of members of the Modifier Subset is used to modify a member of the Main Subset. The preferred method of modifying is such that the modified is in front of the modifier.

6. Generating an ordered list of the members of Stroke Set based on frequencies of usage of strokes

Some strokes of Chinese characters are used more often than others. FIG. 1A and FIG. 1B list the strokes based on frequencies of usage according to a study starting from the highest to the lowest frequency of usage.

The eight strokes with the highest frequencies of usage are [symbol] [symbol] and

[symbol]

7. Partitioning Stroke Set into High Frequency Stroke Subset and Low Frequency Stroke Subset

Using the ordered list of strokes as shown in FIG. 1A and FIG. 1B, Stroke Set is partitioned into High Frequency Stroke Subset and Low Frequency Stroke Subset. High Frequency Stroke Subset includes the 21 strokes of the highest frequencies of usage listed in FIG. 1A and FIG. 1B. Low Frequency Stroke Subset includes the 10 strokes of the lowest frequencies of usage listed in FIG. 1A and FIG. 1B.

8. Generating Stroke Code Set

Each member of Stroke Code Set represents one member of Stroke Set and each member of Stroke Set is represented by one member of Stroke Code Set. A member of Stroke Code Set is a member or combination of members of Symbol Set. A member of Stroke Code Set is called a stroke code. Therefore, a stroke code represents a stroke. Where contexts are clear, ‘stroke code’ and ‘stroke’ may be used interchangeably.

Every member of Stroke Set is assigned a member or combination of members of Symbol Set as the stroke code that represents the member of Stroke Set.

Each member of the High Frequency Stroke Subset is assigned one consonant as the stroke code that represents the member. Each of the eight strokes with the highest frequencies of usage is assigned a consonant from the home row of a QWERTY keyboard.

Each member of the Low Frequency Stroke Subset is assigned a combination of one consonant and one letter ‘a’ as the stroke code that represents the member. The letter ‘a’ is placed right after the consonant.

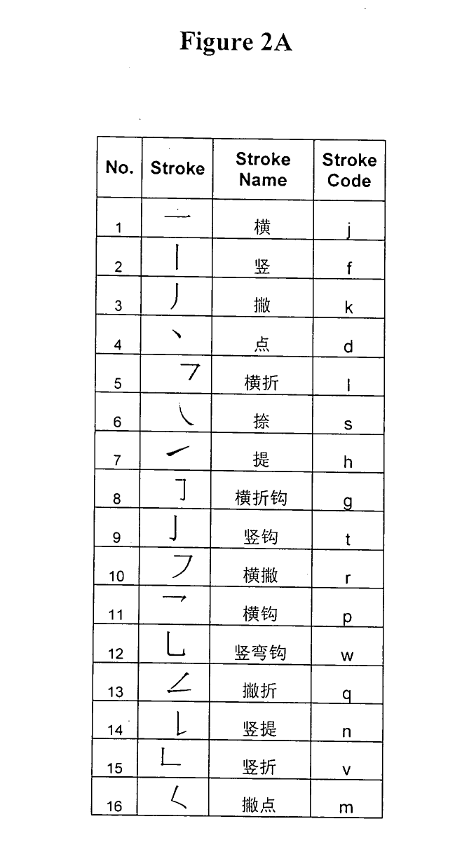

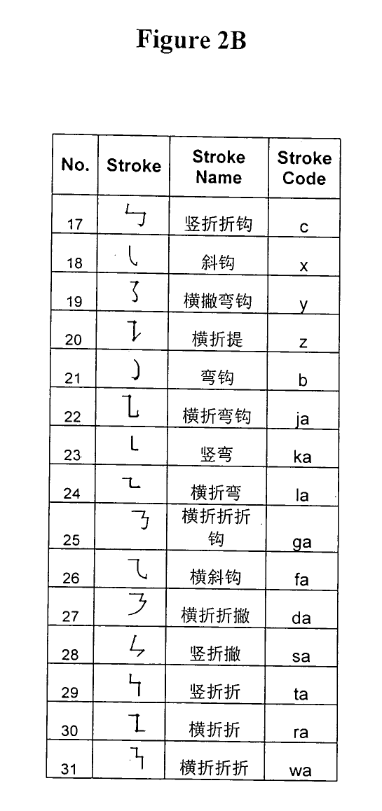

The Stroke Code Set generated is shown in FIG. 2A and FIG. 2B.

9. Generating Sequential Code Table.

Sequential Code Table comprises Chinese characters field and sequential code field is generated. The Chinese characters field includes the Chinese characters to be organized. The sequential code field includes sequential codes. A sequential code includes all the stroke codes representing the strokes used in writing a Chinese character arranged sequentially according to the order of writing the strokes. In a record (row of a table) of Sequential Code Table, the sequential code is related to the Chinese Character in the record.

The government of China has standardized the writing sequence of strokes of Chinese characters in ‘GB13000.1’. GB13000.1 is selected to be used in determining the writing sequence of strokes of Chinese characters.

The construction of a sequential code comprises:

(i) Representing each stroke of a character by a stroke code.

(ii) Arranging the stroke codes for each of the Chinese character according to the order of writing the strokes. For example, [symbol] has three strokes represented by stroke codes ‘j’, ‘f’, and ‘j’. The stroke codes are ordered according to the order of writing the strokes to be ‘jfj’. Therefore, the sequential code for [symbol] is ‘jfj’. Another example, [symbol] has four strokes represented by stroke codes ‘j’, ‘j’, ‘sa’, and ‘d’. After ordering according to the order of writing the strokes, the sequential code for [symbol] is ‘jjsad’.

The Sequential Code Table is shown in Table 1, wherein samples of the Sequential Codes are generated in responsive to the corresponding Chinese characters.

Notice that many of the Chinese characters on the Sequential Code Table, in Table 1, have the same sequential codes. Additional rules are needed to minimize the occurrence of several Chinese characters share the same code.

10. Generating Spatial Code Table

Spatial Code Table comprising of Chinese characters field, sequential code field, and spatial code field is generated. The Chinese characters field and sequential code field has been generated as shown in the Sequential Code Table. The spatial code field includes spatial codes. In a record, the sequential code and spatial code are related to the Chinese character in the record. A spatial code is constructed by modifying the related sequential code according to the Spatial Relationships among the strokes of the Chinese characters. If a stroke code is modified according to several relationships, the modifiers are arranged alphabetically.

Spatial Relationships comprises Intersections Relationship, Horizontal-Horizontal Relationship, Horizontal-Vertical-Horizontal Relationship, Two-Stroke Relationship, and Three-Stroke Relationship.

(A) Intersections Relationship

Each intersection is represented by one ‘e’. Therefore, two intersections are represented by ‘ee’, three intersections are represented by ‘eee’, etc. For example:

(i) [symbol] has a sequential code of ‘jjkf’. The first stroke is ‘j’. There are no other strokes earlier in Sequential Relationship to the first stroke, thus, no modification is needed for the first stroke. The second stroke, ‘j’, does not intersect other strokes that are earlier in Sequential Relationship, thus, no modification is needed for the second stroke. The third stroke, ‘k’, intersects both the first stroke ‘j’ once and the second strokes ‘j’ once, with a total of two intersections, thus, ‘k’ is modified to be ‘kee’. Similarly, ‘f’ intersects both ‘j’ with a total of two intersections, thus, ‘f’ is modified to be ‘fee’. Therefore, the sequential code for [symbol] is modified to be ‘jjkeefee’.

(ii) [symbol] has a sequential code of ‘jjkf’. The stroke ‘k’ intersects with only one ‘j’, thus, ‘k’ is modified to be ‘ke’. Similarly, ‘f’ intersects with only one ‘j’, thus ‘f’ is modified to be ‘fe’. Therefore, the sequential code for [symbol] is modified to be ‘jjkefe’.

(iii) [symbol] has a sequential code of ‘jjkf’. There are no intersections, thus, no modification is needed. Therefore, the modified sequential code for [symbol] is still ‘jjkf’.

(iv) [symbol] has a sequential code of ‘fljjfjj’. The fifth stroke, ‘f’, intersects the third and the fourth strokes with a total of two intersections, thus, the fifth stroke is modified to be ‘fee’. The sixth stroke, ‘j’, intersects the fifth stroke once, thus, the sixth stroke is modified to be ‘je’. Therefore, the spatial code for [symbol] is ‘fljjfeejej’.

(B) Horizontal-Horizontal Relationship

Horizontal-Horizontal Relationship is represented by ‘i’ if all of the followings are observed:

a. Two horizontal strokes are written one right after another.

b. The second horizontal stroke is written right under the first horizontal stroke earlier in Sequential Relationship.

C. The second horizontal stroke is shorter than the first horizontal stroke earlier in Sequential Relationship.

In modifying according to Horizontal-Horizontal Relationship, the modification applies to the second horizontal stroke.

For example:

(i) [symbol] has a sequential code ‘jjj’. The first and the second strokes are two horizontal strokes one written right after another, the second stroke is written right under the first stroke, and the second stroke is shorter than the first stroke, thus, the second stroke is modified to be ‘ji’. The second and third strokes are also two horizontal strokes written one right after another, the third stroke is written right under the second stroke, but the third stroke is not shorter than the second stroke, thus, no modification is needed. Therefore, the spatial code for [symbol] is ‘jjij’.

(ii) [symbol] has a sequential code ‘fjjjfjjj’. The second and the third strokes are two horizontal strokes written one right after another, the third stroke is written right under the second stroke, and the third stroke is shorter than the second stroke, thus, the third stroke is modified to be ‘ji’. Using the stroke code ‘j’ to represent a horizontal stroke, the sixth and the seventh strokes are two ‘j’ one written right after another and the seventh stroke ‘j’ is shorter than the ‘j’ of the sixth stroke, thus, the seventh stroke is modified to be ‘ji’. The third and fourth strokes are two ‘j’ but the fourth stroke is not shorter than the third stroke, thus, the fourth stroke is not modified. Similarly, the eighth stroke is not modified. Therefore, the spatial code for [symbol] is ‘fjjijfjjij’.

(iii) [symbol] has a sequential code ‘jjjfjv’ The first and the second strokes are two ‘j’ written one right after another, the second stroke is written right under the first stroke, and the second stroke is shorter than the first stroke, thus, the second ‘j’ is modified to be ‘ji’. The second and the third strokes are two ‘j’ written one right after another, the third stroke is written right under the second stroke, the third stroke is shorter than the second stroke, thus, the third ‘j’ is modified to be ‘ji’. The stroke ‘f’ is modified to be ‘fe’ according to Intersections Relationship. Therefore, the spatial code for [symbol] is ‘jjijifejv’.

(C) Horizontal-Vertical-Horizontal Relationship

Horizontal-Vertical-Horizontal Relationship is represented by ‘i’ if all of the followings are observed:

a. Three strokes, a horizontal stroke ( [symbol] ), a vertical stroke ( [symbol] , and a horizontal stroke ( [symbol] ) are written one right after another respectively.

b. The third stroke, a horizontal stroke, is written under the first stroke, a horizontal stroke earlier in Sequential Relationship.

c. The third stroke is shorter than the first stroke.

In modifying according to Horizontal-Vertical-Horizontal Relationship, the modification applies to the third stroke.

For example:

(i) [symbol] has a sequential code ‘ddpjfjks’. The fourth, fifth, and sixth strokes are a horizontal stroke, a vertical stroke, and a horizontal stroke, written one right after another respectively, the sixth stroke is written under the fourth stroke, and the sixth stroke is shorter than the fourth stroke, thus, the sixth stroke is modified to be ‘ji’. Therefore, the spatial code for [symbol] is ‘ddpjfjks’.

(ii) [symbol] has a sequential code ‘jfj’. The three strokes are a horizontal stroke, a vertical stroke, and a horizontal stroke, written one right after another respectively, the third stroke is written under the first stroke, and the third stroke is shorter than the first stroke, thus, the third stroke is modified to be ‘ji’. The stroke ‘f’ is modified according to Intersections Relationship. Therefore, the spatial code for [symbol] is ‘jfeji’.

(iii) [symbol] has a sequential code ‘jfj’. The three strokes are a horizontal stroke, a vertical stroke, and a horizontal stroke, written one right after another respectively, the third stroke is written under the first stroke, but the third stroke is not shorter than the first stroke, thus, there is no need for modification according to Horizontal-Vertical-Horizontal Relationship for the third stroke. The stroke ‘f’ is modified according to Intersections Relationship. Therefore, the spatial code for [symbol] is ‘jfej’.

(iv) [symbol] has a sequential code ‘jfj’. No modification is required. Therefore, the spatial code for [symbol] is ‘jfj’.

(D) Two-Stroke Relationship

Two-Stroke Relationship is the relative position of the two strokes, [symbol] and ‘ [symbol] ’ written one right after another respectively in a Chinese character with the forms of ‘ [symbol] (ren)’, ‘ [symbol] (ba)’, or ‘ [symbol] (ru)’ and the two strokes are not separated by another stroke.

Two-Stroke Relationship is represented by ‘oa’ or ‘oe’ depending on the relative positions of the strokes [symbol] and the stroke [symbol] .

Two-Stroke Relationship is represented by ‘oa’ if two strokes, [symbol] and [symbol] are written respectively and take the form of ‘ [symbol] (ba)’.

Two-Stroke Relationship is represented by ‘oe’ if two strokes, [symbol] and [symbol] are written respectively and takes the form of ‘ [symbol] (ru)’.

No modification for Two-Stroke Relationship is needed if two strokes, [symbol] and [symbol] are written respectively and takes the form of ‘ [symbol] (ren)’.

In modifying according to Two-Stroke Relationship, the modification applies to the second stroke.

For example:

(i) [symbol] has a sequential code ‘ks’. The stroke ‘k’ is written right after the stroke ‘s’, strokes ‘k’ and ‘s’ take the form of ‘ [symbol] (ba)’, and not separated by another stroke , thus, the second stroke is modified to be ‘soa’. Therefore, the spatial code for [symbol] is ‘ksoa’.

(ii) [symbol] has a sequential code ‘ksgk’. The stroke ‘k’ is written right after the stroke ‘s’, strokes ‘k’ and ‘s’ take the form of ‘ [symbol] (ba)’, and not separated by another stroke , thus, the second stroke is modified to be ‘soa’. Therefore, the spatial code for [symbol] is ‘ksoagk’.

(iii) [symbol] has a sequential code ‘ks’. The stroke ‘k’ is written right after the stroke ‘s’, strokes ‘k’ and ‘s’ take the form of ‘ [symbol] (ru)’, and not separated by another stroke, thus, the second stroke is modified to be ‘soe’. Therefore, the spatial code for [symbol] is ‘ksoe’.

(iv) [symbol] has a sequential code ‘ks’. No modification is needed. Therefore, the spatial code for [symbol] is ‘ks’.

(v) [symbol] has a sequential code ‘jfkdjfks’. The last two strokes are ‘k’ and ‘s’ written one right after another respectively but separated by a vertical stroke, thus, no modification according to Two-Stroke Relationship is needed. With modification according to Intersections Relationship, the spatial code for [symbol] is ‘jfekdjfeks’.

(vi) [symbol] has a sequential code ‘ksjflj’. The first two strokes have the form of‘ [symbol] (ren)’, thus, no modification is needed. Therefore, the spatial code for [symbol] is ‘ksjflj’.

(E) Three-Stroke Relationship

Three-Stroke Relationship is the relative position of the three strokes, [symbol] and [symbol] written one right after another respectively in a Chinese character with the forms ‘ [symbol] (i)’, ‘ [symbol] (yi)’, or ‘ [symbol] (si)’.

Three-Stroke Relationship is represented by ‘oa’ or ‘oe’ depending on the relative positions of the strokes [symbol] and

[symbol]

Three-Stroke Relationship is represented by ‘oa’ if three strokes, [symbol] and [symbol] are written respectively and take the form of ‘ [symbol] yi)’.

Three-Stroke Relationship is represented by ‘oe’ if three strokes, [symbol] and [symbol] are written respectively and take the form of ‘ [symbol] (si)’.

No modification according to Three-Stroke Relationship is needed if three strokes, [symbol] and [symbol] are written respectively and take the form of ‘ [symbol] (ji)’.

In modifying according to Three-Stroke Relationship, the modification applies to the third stroke.

For example:

(i) [symbol] has a sequential code ‘ljw’. The three strokes have the form of ‘ [symbol] (yi)’, thus, the third stroke is modified to be ‘woa’. Therefore, the spatial code for [symbol] is ‘ljwoa’.

(ii) [symbol] has a sequential code ‘ljw’. The three strokes have the form of ‘ [symbol] (si)’, thus, the third stroke is modified to be ‘woe’. Therefore, the spatial code for [symbol] is ‘ljwoe’.

(iii) [symbol] has a sequential code ‘ljw’. The three strokes have the form of ‘ [symbol] (ji)’, thus, no modification for Three-Stroke Relationship is needed. Therefore, the spatial code for [symbol] is ‘ljw’.

(iv) [symbol] has a sequential code ‘jfhljw’. The last three strokes have the form of ‘ [symbol] (ji)’, thus, no modification for Three-Stroke Relationship is needed. The stroke ‘f’ is modified according to Intersections Relationship. Therefore, the spatial code for [symbol] is ‘jfehljw’.

(v) [symbol] has a sequential code ‘jfhljw’. The three strokes have the form of ‘ [symbol] (si)’, thus, the third stroke is modified to be ‘woe’. The stroke ‘f’ is modified according to Intersections Relationship. Therefore, the spatial code for [symbol] is ‘jfehljwoe’.

The Spatial Code Table is shown in Table 2, wherein samples of the Spatial Codes are generated in responsive to the corresponding sequential codes and Chinese characters.

11. Generating Character Code Table

Character Code Table comprises a Chinese characters field, a spatial code field, and a character code field is generated. The Chinese characters field and the spatial code field have been generated as shown in the Spatial Code Table in Table 2. The character code field includes character codes. In a record, the spatial code and character code are related to the Chinese character in the record. A character code is constructed by inserting as many grouping agents as desired. A grouping agent is a blank space or a symbol that is not a member of Symbol Set.

A grouping agent is used for grouping stroke codes in a spatial code such that the grouping agent makes the use of the character code is easier. The number of grouping agents needed depends on how the character code is used. If a character code is rather long and to be read by a human, several grouping agents are desired. If a character code is rather long and to be used by a machine, no grouping agent is needed. If a character code is short, grouping agents may or may not be needed.

It is desirable to insert grouping agents into a spatial code in a consistent way, but being consistent is not a requirement.

For the preferred embodiment, assuming the character codes to be generated are to be read by a human, let us select a blank space to be used as the grouping agent. For example:

(i) [symbol] has a spatial code of ‘djdkjfljj’. The character code for [symbol] is constructed by inserting a space between the fifth stroke and the sixth stroke. Therefore, the stroke code for [symbol] is ‘djdkj fljj’.

(ii) [symbol] has a spatial code ‘jjkeefee’. Inserting a space between the second and the third strokes makes the character code for [symbol] be ‘jj keefee’.

(iii) [symbol] has a spatial code ‘jjkefe’. No grouping agent is desired. Therefore, the character code for [symbol] is ‘jjkefe’.

(iv) [symbol] has a spatial code ‘jfekdjfeks’. Inserting a space into the spatial code makes the character code for [symbol] be ‘jfekd jfeks’.

(v) [symbol] has a spatial code ‘jjijifejv’. Inserting grouping agents into the spatial code makes the character code for [symbol] be ‘j jiji fej v’.

(vi) [symbol] has a spatial code ‘ksoagk’. Inserting a grouping agent into the spatial code makes the character code for [symbol] be ‘ksoa gk’.

The Character Code Table is shown in Table 3, wherein samples of the Character Codes are generated in responsive to the corresponding spatial codes and Chinese characters.

12. Organizing the Character Code Table

The Character Code Table is organized by ordering the character codes in the Character Code Table such that the Character Code Table can be used to locate a Chinese character easily. The character codes are sorted or ordered alphabetically where the grouping agents are ignored. Ignoring grouping agents in ordering the character codes is effectively the same as sorting or ordering by the spatial code field.

By sorting or ordering the character codes in the Character Code Table, the Chinese characters are organized. A character code can be located easily in the ordered character code field of the Character Code Table. By locating the character code of a Chinese character in the character code field, the Chinese character can be easily located in the record where the character code is located.

The alphabetically ordered Character Code Table is shown in Table 4, wherein the samples of the Character Codes are sorted in an alphabetical order.

13. Using the present invention

(I) To compile a dictionary

A dictionary with entries comprising of the records of the ordered Character Code Table is compiled.

To locate a Chinese character, for example [symbol] in the compiled dictionary:

a. generating the character code that represents [symbol] ‘jfekd jfeks’, then

b. locating ‘jfekd jfeks’ in the compiled dictionary where the character codes are ordered alphabetically by ignoring the grouping agents, then

c. Chinese character [symbol] is located next to the character code ‘jfekd jfeks’ in the compiled dictionary.

(II) To data and word process Chinese characters in the Character Code Table

The ordered Character Code Table is inserted in software capable of processing a table.

To process a Chinese character, for example [symbol] using the software with the inserted ordered Character Code Table:

a. generating the character code that represents [symbol] ‘jfekd jfeks’, then

b. inputting ‘jfekd jfeks’ using the software interface, then

c. using the ordered Character Code Table, the software locates the record that contained ‘jfekd jfeks’ in the character code field, then

d. using the ordered Character Code Table, the software locates the Chinese character [symbol] in the Chinese characters field on the same record, then

e. using the Chinese character [symbol] found, the software processes it further by copying, pasting, or printing, etc., depending on the need of the user.

Thus, a user can easily generate the character code for a Chinese character as if he or she is writing the Chinese character by hand, and with the ordered Character Code Table, a Chinese character can easily and efficiently be located and be processed. On rare cases where a character code represents more than one Chinese character, the user should select the Chinese character accordingly.

Although the description above contains many specificities, these should not be construed as limiting the scope of the invention but as merely providing illustrations of some of the presently preferred embodiments of this invention. For example, alphabet of any language can be used instead of the English alphabet, numerals, or any set of symbols that can be ordered can be used instead of the English alphabet. Additionally, any container that is capable of containing data and the relationship between data can be used instead of a table.

Thus the scope of the invention should be determined by the appended claims and their legal equivalents, rather by the examples given.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

TABLE 1
(Generated Sequential Code Table)

| Chinese | Sequential |
|---|---|
| Characters | Code |
| [symbol] | jfj |
| [symbol] | djdkjfljj |
| [symbol] | jf |
| [symbol] | jjkf |
| [symbol] | jjkf |
| [symbol] | jjkf |
| [symbol] | fljf |
| [symbol] | jj$$ad |
| [symbol] | fljjfjj |
| [symbol] | jjj |
| [symbol] | jjfks |
| [symbol] | jjf$$s |
| [symbol] | jjjfjv |
| [symbol] | fjjjfjjj |
| [symbol] | jfj |
| [symbol] | jfj |
| [symbol] | fljfjks |
| [symbol] | ddpjfjks |
| [symbol] | ks |
| [symbol] | ks |
| [symbol] | ks |
| [symbol] | ddpks |
| [symbol] | jfkdjfks |
| [symbol] | k$$k |
| [symbol] | ksjflj |
| [symbol] | ljw |
| [symbol] | ljw |
| [symbol] | ljw |
| [symbol] | dzljw |
| [symbol] | jfhljw |
| [symbol] | jfhljw |

TABLE 2
(Generated Spatial Code Table)

| Chinese | Sequential | Spatial |
|---|---|---|
| Characters | Code | Code |
| [symbol] | jfj | jfj |
| [symbol] | djdkjfljj | djdkjfljj |
| [symbol] | jf | jfe |
| [symbol] | jjkf | jjkeefee |
| [symbol] | jjkf | jjkefe |
| [symbol] | jjkf | jjkf |
| [symbol] | fljf | fljfee |
| [symbol] | jjsad | jjsaeed |
| [symbol] | fljjfjj | fljjfeejej |
| [symbol] | jjj | jjij |
| [symbol] | jjfks | jjifeeks |
| [symbol] | jjfks | jjfeeks |
| [symbol] | jjfjv | jjijifejv |
| [symbol] | fjjj$$jjj | fjjijfjjij |
| [symbol] | jfj | jfeji |
| [symbol] | jfj | jfej |
| [symbol] | fljfjks | fljfjiks |
| [symbol] | ddpjfjks | ddpjfjiks |
| [symbol] | ks | ksoa |
| [symbol] | ks | ksoe |
| [symbol] | ks | ks |
| [symbol] | ddpks | ddpksoa |
| [symbol] | jfkdjfks | jfekdjfeks |
| [symbol] | ksgk | ksoagk |
| [symbol] | ksjflj | ksjflj |
| [symbol] | ljw | ljw |
| [symbol] | ljw | ljwoa |
| [symbol] | ljw | ljwoe |
| [symbol] | dzljw | dzljw |
| [symbol] | jfhljw | jfehljw |
| [symbol] | jfhljw | jfehljwoe |

TABLE 3
(Generated Character Code Table)

| Chinese | Spatial | Character |
|---|---|---|
| Characters | Code | Code |
| [symbol] | jfj | jfj |
| [symbol] | djdkjfljj | djdkj fljj |
| [symbol] | jfe | jfe |
| [symbol] | jjkeefee | jj keefee |
| [symbol] | jjkefe | jj kefe |
| [symbol] | jjkf | jjkf |
| [symbol] | fljfee | flj fee |
| [symbol] | jjsaeed | jj saeed |
| [symbol] | fljjfeejej | fljj feejej |
| [symbol] | jjij | jjij |
| [symbol] | jjifeeks | jji feeks |
| [symbol] | jjfeeks | jj feeks |
| [symbol] | jjijifejv | j jiji fej v |
| [symbol] | fjjijfjjij | fjjij fjjij |
| [symbol] | jfeji | jfeji |
| [symbol] | jfej | jfej |
| [symbol] | fljfjiks | flj fjiks |
| [symbol] | ddpjfjiks | ddp jfjiks |
| [symbol] | ksoa | ksoa |
| [symbol] | ksoe | ksoe |
| [symbol] | ks | ks |
| [symbol] | ddpksoa | ddp ksoa |
| [symbol] | jfekdjfeks | jfekd jfeks |
| [symbol] | ksoagk | ksoa gk |
| [symbol] | ksjflj | ksj flj |
| [symbol] | ljw | ljw |
| [symbol] | ljwoa | ljwoa |
| [symbol] | ljwoe | ljwoe |
| [symbol] | dzljw | dz ljw |
| [symbol] | jfehljw | jfeh ljw |
| [symbol] | jfehljwoe | jfeh ljwoe |

TABLE 4
(Alphabetically Ordered Character Code Table)

| Chinese | Spatial | Character |
|---|---|---|
| Characters | Code | Code |
| [symbol] | ddpjfjiks | ddp jfjiks |
| [symbol] | ddpksoa | ddp ksoa |
| [symbol] | djdkjfljj | djdkj fljj |
| [symbol] | dzljw | dz ljw |
| [symbol] | fjjijfjjij | fjjij fjjij |
| [symbol] | fljfee | flj fee |
| [symbol] | fljfjiks | flj fjiks |
| [symbol] | fljjfeejej | fljj feejej |
| [symbol] | jfe | jfe |
| [symbol] | jfehljw | jfeh ljw |
| [symbol] | jfehljwoe | jfeh ljwoe |
| [symbol] | jfej | jfej |
| [symbol] | jfeji | jfeji |
| [symbol] | jfekdjfeks | jfekd jfeks |
| [symbol] | jfj | jfj |
| [symbol] | jjfeeks | jj feeks |
| [symbol] | jjifeeks | jji feeks |
| [symbol] | jjij | jjij |
| [symbol] | jjijifejv | j jiji fej v |
| [symbol] | jjkeefee | jj keefee |
| [symbol] | jjkefe | jj kefe |
| [symbol] | jjkf | jjkf |
| [symbol] | jjsaeed | jj saeed |
| [symbol] | ks | ks |
| [symbol] | ksjflj | ksj flj |
| [symbol] | ksoa | ksoa |
| [symbol] | ksoagk | ksoa gk |
| [symbol] | ksoe | ksoe |
| [symbol] | ljw | ljw |
| [symbol] | ljwoa | ljwoa |
| [symbol] | ljwoe | ljwoe |

What is claimed is:

1. A method of organizing Chinese characters, comprising the steps of:
(a) generating Stroke Set which includes all strokes used in writing Chinese characters;
(b) generating Symbol Set which includes members adapted for being arranged in an ordered list;
(c) generating Stroke Code Set which includes stroke codes as members such that each member of said Stroke Set is represented by a member of said Stroke Code Set, and a member of said Stroke Code Set is a combination of members of said Symbol Set;
(d) generating a sequential code for each of Chinese characters to be organized wherein said sequential code is a code related to said each of Chinese characters to be organized such that said sequential code includes all the stroke codes of strokes used in writing said each of Chinese characters to be organized arranged sequentially according to the order of writing the strokes of said each of Chinese characters to be organized;
(e) generating a spatial code for said each of Chinese characters to be organized by modifying said sequential code according to Spatial Relationships of strokes in said each of Chinese characters to be organized;
(f) generating a character code to represent said each of Chinese characters to be organized by grouping stroke codes of said each of spatial codes; and
(g) orderly sorting said character codes together with Chinese characters represented by said character codes, whereby said Chinese characters are organized and are adapted to be used as a means for word processing, data processing, or compiling a dictionary.

2. A method of organizing Chinese characters, as recited in claim 1, wherein at least one of said stroke codes of said Stroke Code Set is constructed from a combination of at least two said members of said Symbol Set.

3. A method of organizing Chinese characters, as recited in claim 1, wherein said spatial codes are constructed in responsive to Intersection Relationships.

4. A method of organizing Chinese characters, as recited in claim 3, wherein each of said Intersection Relationships is represented by at least one symbol indicating the number of intersections of said corresponding Chinese character.

5. A method of organizing Chinese characters, as recited in claim 1, wherein said spatial codes are constructed in responsive to Horizontal-Horizontal Relationships.

6. A, method of organizing Chinese characters, as recited in claim 5, wherein at least one of the two types of said Horizontal-Horizontal Relationships is represented by at least one symbol.

7. A method of organizing Chinese characters, as recited in claim 1, wherein said spatial codes are constructed in responsive to Horizontal-Vertical-Horizontal Relationships.

8. A method of organizing Chinese characters, as recited in claim 7, wherein at least one of the two types of said Horizontal-Vertical-Horizontal Relationships is represented by at least one symbol.

9. A method of organizing Chinese characters, as recited in claim 1, wherein said spatial codes are constructed in responsive to Two-Stroke Relationships.

10. A method of organizing Chinese characters, as recited in claim 9, wherein at least one of the three types of said Two-Stroke Relationships is represented by at least one symbol.

11. A method of organizing Chinese characters, as recited in claim 1, wherein said spatial codes are constructed in responsive to Three-Stroke Relationships.

12. A method of organizing Chinese characters, as recited in claim 11, wherein at least one of the three types of said Three-Stroke Relationships is represented by at least one symbol.

13. A method of organizing Chinese characters, as recited in claim 1, wherein said Symbol Set is partitioned into Main Subset and Modifier Subset.

14. A method of organizing Chinese characters, as recited in claim 1, wherein each of said character codes is constructed by selectively inserting at least a grouping agent into said spatial code.

15. A method of organizing Chinese characters, as recited in claim 1, wherein said Symbol Set is the English alphabet.

16. A method of organizing Chinese characters, as recited in claim 15, wherein said Symbol Set is partitioned into Main-Alphabet Subset and Modifier-Alphabet Subset.

17. A method of organizing Chinese characters, as recited in claim 16, wherein said Main-Alphabet Subset includes consonants of said English alphabet.

18. A method of organizing Chinese characters, as recited in claim 16, wherein said Modifier-Alphabet Subset includes vowels of said English alphabet.

19. A method of organizing Chinese characters, as recited in claim 1, wherein at least one of said stroke codes of said Stroke Code Set is constructed from a combination of at least two letters of English alphabet.

20. A method of organizing Chinese characters, as recited in claim 19, wherein at least one letter of said combination of at least two letters of said English alphabet is a member of Modifier-Alphabet Subset.

21. A method of organizing Chinese characters, as recited in claim 19, wherein at least one letter of said combination of at least two letters of said English alphabet is a member of Main-Alphabet Subset.

22. A method of organizing Chinese characters, as recited in claim 21, wherein members of said Main-Alphabet Subset are written before members of said Modifier-Alphabet Subset.

23. A method of organizing Chinese characters, as recited in claim 1, wherein said Stroke Set is partitioned into a High Frequency Stroke Subset and a Low Frequency Stroke Subset, wherein a member of said High Frequency Stroke Subset is represented by a letter of English alphabet.

24. A method of organizing Chinese characters, as recited in claim 1, wherein said Stroke Set is partitioned into a High Frequency Stroke Subset and a Low Frequency Stroke Subset, wherein a member of said Low Frequency Stroke Subset is represented by at least two letters of English alphabet.

25. A method of organizing Chinese characters, as recited in claim 24, wherein said members of said High Frequency Stroke Subset with the highest frequencies of usage are said letters of English alphabet located in a home row of a typing keyboard.
